(19) United States
(12) Patent Application Publication
(10) Pub. No.: US 2006/0123999 A1
(43) Pub. Date: Jun. 15, 2006

(54) Motor assembly with water control features

(75) Inventors: Eric Raymond Bartlett, London (CA); Bryan Todd Fisher, Appin (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Inc.

(21) Appl. No.: 11/301,431

(22) Filed: Dec. 13, 2005

Related U.S. Application Data
(60) Provisional application No. 60/636,037, filed on Dec. 14, 2004.

(51) Int. Cl. A23B 4/14

(52) U.S. Cl. 99/516

(57) ABSTRACT

A motor assembly 10 includes motor 14 having a rotatable shaft 15. A cover 16 has a flange 18 including a motor support 20 therein receiving at least a portion of the motor 14 therein. The cover 16 includes a water dam 22 extending from a surface of the flange and substantially surrounding the motor support 20. The water dam is constructed and arranged to generally block water from entering the motor support. The cover 16 includes a water drain channel 26 therein, with one end of the channel communicating with the motor support and the other end of the channel being spaced from the motor support and extending towards a periphery of the cover. The channel 26 is constructed and arranged to permit water that enters the motor support to drain from the motor support. A vent tube 30 is coupled with the cover and in communication with the motor support. The vent tube is constructed and arranged to be coupled with a source of dry air such that dry air from the source can enter the motor support via the vent tube.

This application is flanged on U.S. Provisional Application No. 60/636,037, filed on Dec. 14, 2004, and claims the benefit thereof for priority purposes.

### FIELD OF THE INVENTION

This invention relates to motors for automotive applications such as, but not limited to, engine cooling, HVAC (Heating, Ventilation and Air Conditioning) and, more particular, to a motor assembly that controls water that may enter the motor assembly.

### BACKGROUND OF THE INVENTION

Motors used in automotive applications are often exposed to harsh environments. Water can enter a motor and could cause the motor to fail, or could shorten the life of the motor.

There is a need for a motor assembly to include features for controlling water that may enter the motor assembly and for supplying dry air to the motor.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a side perspective view of a motor assembly with a blower wheel attached thereto, the motor assembly having water control features provided in accordance with the principles of the present invention.

FIG. 2 is a top view of the motor assembly of FIG. 1.

FIG. 3 is a top view of the cover of the motor assembly of FIG. 2.

FIG. 4 is a side view of the motor assembly, with the blower wheel attached, and shown coupled to an evaporator case in a vehicle mounting position.

FIG. 5 is a view of the motor assembly, blower wheel attached and evaporator case of FIG. 4 oriented to shown a vent tube.

### SUMMARY OF THE INVENTION

An object of the invention is to fulfill the need referred to above. In accordance with the principles of the present invention, this objective is obtained by providing a motor assembly including a motor having a rotatable shaft, and a cover having a flange. The flange includes a motor support therein receiving at least a portion of the motor within the motor support. The cover includes a water dam extending from a surface of the flange and substantially surrounding the motor support. The water dam is constructed and arranged to generally block water from entering the motor support. The cover includes a water drain channel therein, with a first end of the channel communicating with the motor support and a second end of the channel being spaced from the motor support and extending towards a periphery of the flange. The channel is constructed and arranged to permit water that enters the motor support to drain from the motor support. The assembly includes a vent tube coupled with the cover and in communication with the motor support. The vent tube is constructed and arranged to be coupled with a source of dry air such that dry air from the source can enter the motor support via the vent tube to cool the motor.

In accordance with another aspect of the invention a motor assembly includes motor having a rotatable shaft, a cover having a flange, the flange including a motor support therein receiving at least a portion of the motor within the motor support, and a vent tube coupled with the cover and in communication with the motor support. The vent tube is constructed and arranged to be coupled with dry air from an evaporator case such that the dry air can enter the motor support via the vent tube.

In accordance with yet another aspect of the invention, a method of draining water and providing airflow to a motor provides a motor having a rotatable shaft. A cover is provided that has a flange. The flange includes a motor support therein receiving at least a portion of the motor within the motor support. The cover includes a water dam extending from a surface of the flange and substantially surrounding the motor support. The water dam is constructed and arranged to generally block water from entering the motor support. The cover includes a water drain channel therein, with a first end of the channel communicating with the motor support and a second end of the channel being spaced from the motor support and extending towards a periphery of the flange. Water that enters the motor support is permitted to drain from the assembly via the channel. A vent tube is coupled with the cover and is in communication with the motor support. Dry air from a source of dry air is supplied to the vent tube and thus to the motor support.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### DETAILED DESCRIPTION OF THE EXEMPLARY EMBODIMENT

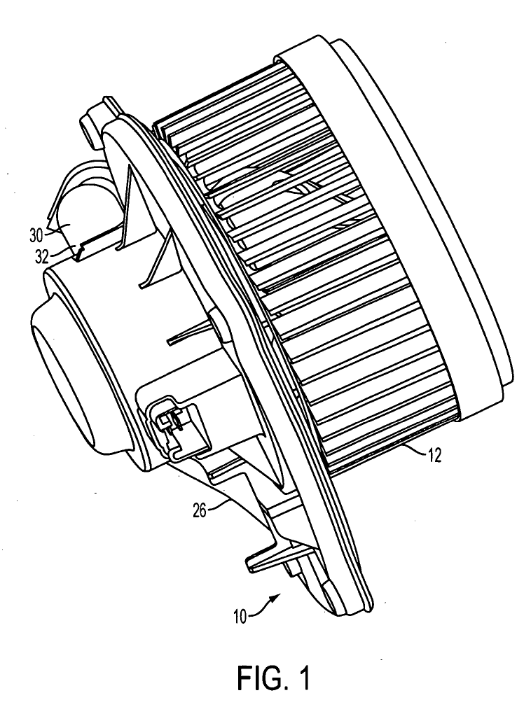

With reference to FIG. 1, a motor assembly is shown, generally indicated at 10, having a blower wheel 12 attached thereto. The motor assembly 10 is preferably used in automotive applications such as, but is not limited to, engine cooling, HVAC (Heating, Ventilation and Air Conditioning).

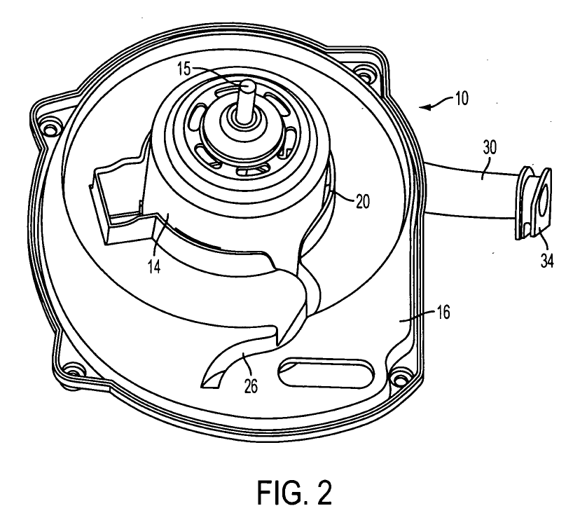

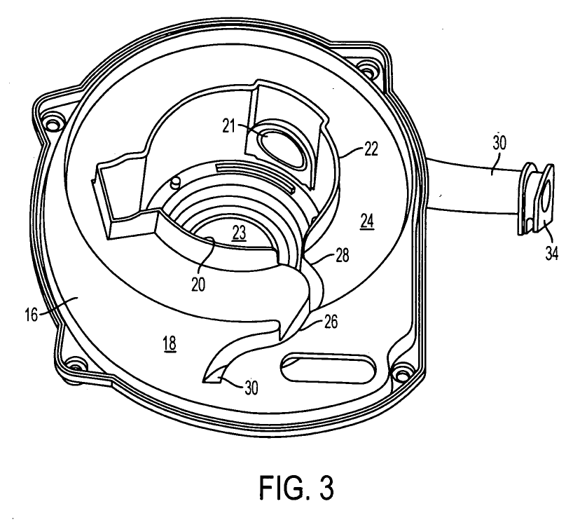

With reference to FIG. 2, in accordance with the principles of the invention, the motor assembly 10 includes a motor 14 having a rotatable shaft 15 (that is coupled with the wheel 12 of FIG. 1), and a cover 16 that receives an end of the motor 14 opposite the shaft end. More particularly, as shown in FIG. 3, the cover 16 includes a flange 18 including a motor support 20 therein having a closed end and an open end. The motor support 20 is constructed and arranged to receive, via the open end, at least a portion of the motor 14. Substantially surrounding the motor support 20 is water dam 22 that extends from surface 24 of the flange 18. The water dam 22 is constructed and arranged to generally block water from entering the motor support 20.

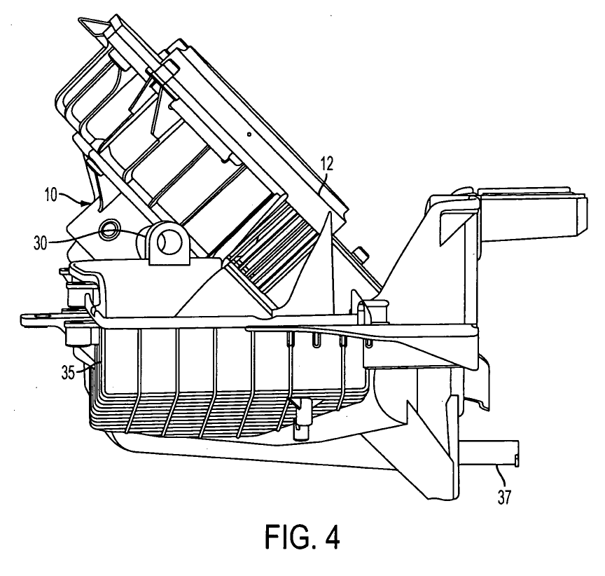

Should water enter the motor support 20, the cover 16 includes a water drain channel 26 therein. One end 28 of the channel communicates with the motor support 20 and extends towards a periphery of the flange 16. The assembly is mounted at an angle such that end 28 is at a higher elevation at the closed end of the motor support than lower end 30. In addition, the channel 26 tapers from a deep end 28 that is communication with the bottom 23 of the motor support 20 to the shallow end 30. Thus, if water does enter the motor support 20, as shown in FIG. 4, the water can drain out of the cover 16, via the drain channel 26, from under the blower wheel 12. The drain channel 26 is functional when the motor assembly 10 is mounted with the shaft 15 in a horizontal position, up to a shaft position of about 45 degrees with respect to the horizontal shaft position. Thus, it is clear that gravity will cause the water to flow from the motor support 20 through the drain channel 26. The motor assembly 10 with blower wheel 12 attached is shown mounted in the 45-degree angle shaft position in FIG. 1, with the channel 26 oriented generally downwardly.

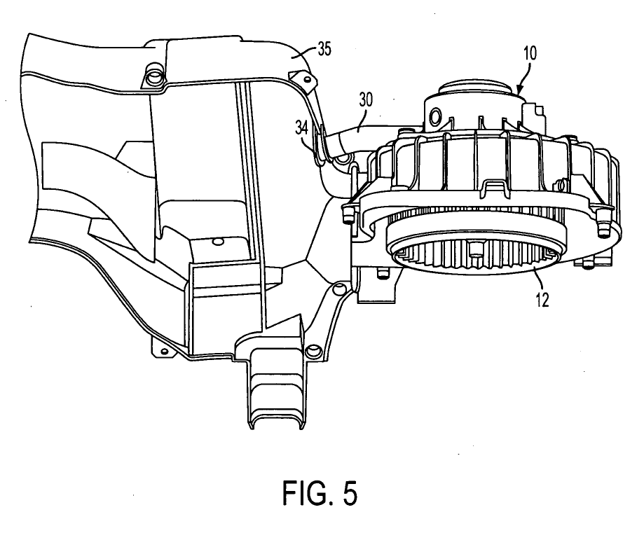

With reference to FIGS. 1 and 3, a vent tube 30 preferably of Ethylene Propylene Diene Monomer, is coupled with the cover 16 at one end 32 thereof such that the vent tube 30 is in communication with the motor support 20 via port 21. The other end 34 of the vent tube is constructed and arranged to tap into dry air from a source further downstream when the motor assembly 10 is mounted in a vehicle. More particularly, with reference to FIGS. 4 and 5, the vent tube 30 via end 34 taps into an evaporator case 35 just before the evaporator (not shown) and past the cutoff point of the scroll (not shown). FIG. 4 shows the assembly disposed in a mounting position in a vehicle and shows a water drain 37 in the plenum or evaporator case 35. FIG. 5 is a view of the assembly that clearly shows the vent tube 30. Thus, although the blower 12 may expel water onto the evaporator case 35, the vent tube 30 is oriented so that water cannot easily enter the end of the vent tube 30, ensuring dry air is delivered to the motor support 20.

It can be appreciated that the motor assembly 10 with dam 20, drainage channel 26, and vent tube 30 suitably removes water from the motor area and provides dry air to the motor 14.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A motor assembly comprising:
a motor having a rotatable shaft,
a cover having a flange, the flange including a motor support therein receiving at least a portion of the motor within the motor support, the cover includes a water dam extending from a surface of the flange and substantially surrounding the motor support, the water dam being constructed and arranged to generally block water from entering the motor support, the cover includes a water drain channel therein, with a first end of the channel communicating with the motor support and a second end of the channel being spaced from the motor support and extending towards a periphery of the cover, the channel being constructed and arranged to permit water that enters the motor support to drain from the motor support, and
a vent tube coupled with the cover and in communication with the motor support, the vent tube being constructed and arranged to be coupled with a source of dry air such that dry air from the source can enter the motor support via the vent tube.

2. The assembly of claim 1, further comprising a blower wheel coupled to the shaft.

3. The assembly of claim 1, wherein the cover has a port in communication with the motor support, the vent tube being a tube separate from the cover and having a first end connected with the port.

4. The assembly of claim 3, in combination with an evaporator case, the tube having a second end connected with the evaporator case.

5. The assembly of claim 1, wherein the vent tube is of Ethylene Propylene Diene Monomer material.

6. The assembly of claim 1, wherein the first end of the channel is in communication with a bottom of the motor support and the channel tapers from the first end to the second end, the second end being less deep than the first end.

7. A motor assembly comprising:
a motor having a rotatable shaft,
a cover having a flange, the flange including means for receiving at least a portion of the motor therein, the cover includes means, extending from a surface of the flange and substantially surrounding the motor support, for blocking water from entering the means for receiving, the cover includes means for draining water, with a first end of the means for draining communicating with the means for receiving and a second end of the means for draining being spaced from the means for receiving and extending towards a periphery of the cover, the means for draining being constructed and arranged to permit water that enters the means for receiving to drain there-from, and
means, coupled with the cover and in communication with the means for receiving, for coupling with a source of dry air such that dry air from the source can enter the means for receiving.

8. The assembly of claim 7, further comprising a blower wheel coupled to the shaft.

9. The assembly of claim 7, wherein the cover has a port in communication with the means for receiving, the means for coupling being a vent tube separate from the cover and having a first end connected with the port.

10. The assembly of claim 9, in combination with an evaporator case, the vent tube having a second end connected with the evaporator case.

11. The assembly of claim 9, wherein the vent tube is of Ethylene Propylene Diene Monomer material.

12. The assembly of claim 7, wherein the means for receiving is a motor support and the first end of the means for draining is in communication with a bottom of the motor support and the means for draining is a channel that from the first end to the second end, the second end being less deep than the first end.

13. A method of draining water and providing airflow to a motor, the method including:
providing a motor having a rotatable shaft,
providing a cover having a flange, the flange including a motor support therein receiving at least a portion of the motor within the motor support, the cover includes a water dam extending from a surface of the flange and substantially surrounding the motor support, the water dam being constructed and arranged to generally block water from entering the motor support, the cover include a water drain channel therein, with a first end of the channel communicating with the motor support and a second end of the channel being spaced from the motor support and extending towards a periphery of the cover,
permitting water that enters the motor support to drain from the assembly via the channel,
providing a vent tube coupled with the cover and in communication with the motor support, and
supplying dry air from a source of dry air to the vent tube and thus to the motor support.

14. The method of claim 13, wherein the motor assembly is mounted in a vehicle and the method further includes coupling the vent tube between the motor support and an evaporator case of the vehicle.

15. The method of claim 13, further comprising providing a blower wheel coupled to the shaft.

16. The method of claim 13, wherein the step of permitting water to drain includes:
ensuring that the first end of the channel is in communication with a bottom of the motor support, with the channel tapering from the first end to the second end, with the second end being less deep than the first end, and
orienting the assembly such that water is removed from the second end of the channel by gravity.

17. The method of claim 16, Wherein the assembly is mounted with the shaft in a range of positions including from a horizontal position, up to a shaft position of about 45 degrees with respect to the horizontal shaft position, with the channel oriented generally downwardly.

18. A motor assembly comprising:
a motor having a rotatable shaft,
a cover having a flange, the flange including a motor support therein receiving at least a portion of the motor within the motor support, and
a vent tube coupled with the cover and in communication with the motor support, the vent tube being constructed and arranged to be coupled with dry air from an evaporator case such that the dry air can enter the motor support via the vent tube.

19. The assembly of claim 18, wherein the cover has a port in communication with the motor support, the vent tube being a tube separate from the cover and having a first end connected with the port.

20. The assembly of claim 19, in combination with the evaporator case, the tube having a second end connected with the evaporator case.
